(19) United States
(12) Patent Application Publication
(10) Pub. No.: US 2013/0077081 A1
(43) Pub. Date: Mar. 28, 2013

(54) LASER RANGEFINDER

(71) Applicant: Hong-Yu LIN, Taichung (TW)

(72) Inventor: Hong-Yu LIN, Taichung (TW)

(21) Appl. No.: 13/242,024

(22) Filed: Sep. 23, 2011

(51) Int. Cl. G01C 3/08

(52) U.S. Cl. 356/3.01

(57) ABSTRACT

A laser rangefinder of the present invention is utilized for detecting and displaying the distance user interests in. The laser rangefinder has a range detector and an angle detector. Thus, the laser rangefinder is able to detecting a distance between an object and the laser rangefinder and an oblique angle thereof. The laser rangefinder further has a micro processor which provides a horizontal distance according to the distance and the angle detected above. As such, the laser rangefinder can show up with the horizontal distance between the object and the laser rangefinder without disturbance of oblique thereof.

### BACKGROUND OF THE INVENTION

1. Field of the Invention

The present invention relates to a laser rangefinder.

2. Description of the Prior Art

Conventional laser rangefinder is used for detecting distance of an object away from user. The distance detected is then displayed with metric system or imperial system. Since the laser rangefinder brings convenience to the distance measurement, it is widely utilized and welcomed in building construction.

Besides, measurement can be processed with measuring tape, also. User can pull the tape by hand, and read the value of distance on the tape directly. Measuring tape is also welcomed in convenience and reliability.

However, both of convention laser rangefinder and measuring tape can not fulfill user's requirements completely. In building construction, distance measuring means confirming not only exact distance, but horizontal distance. In fact, the latter is the important one in which users really interest. No matter laser rangefinder nor measuring tape can hardly determine the horizontal distance directly since user's hand or the instrument can difficult to be kept horizontally. Once user's hand dips or just leaves from the horizontal plane, the value which is read out from the instruments would be inaccurate. Thus, building based on the blueprint could hardly be proceeded precisely. Quality of construction can not be maintained well, or the cost time of construction would be inevitably prolonged.

The present invention is, therefore, arisen to obviate or at least mitigate the above mentioned disadvantages.

### SUMMARY OF THE INVENTION

The main object of the present invention is to provide a laser rangefinder which is able to find the horizontal distance easily so as to improve quality and efficiency of building construction.

To achieve the above and other objects, a laser rangefinder of the present invention includes a main body, a power supplier, a range detector, an angle detector, a micro processor, a screen, and an operation portion.

The range detector is firmly disposed on a surface of the main body. The range finder is connected to the power supplier. The range detector emits a pulse signal toward an object along a detection direction. The range detector receives the pulse signal after the pulse signal is reflected by the object. The range detector generates a distance signal corresponding to a value of a distance between the range detector and the object which is substantially equal to a value of a distance between the main body and the object.

The angle detector is firmly disposed in the main body. The angle detector generates an angle signal corresponding to a value of an oblique angle defined between the detection direction and a horizontal direction.

The micro processor is connected to the range detector and the angle detector. The micro processor receives the distance signal and the angle signal so as to provide a horizontal distance according to the distance signal and the angle signal.

The screen is firmly disposed on the main body. The screen is connected to the micro processor. The micro processor controls the screen to display image. The micro processor controls the screen to display a horizontal distance label according to the horizontal distance.

The operation portion is firmly disposed on the main body. The operation portion comprises at least one operation button. The micro processor connects to the operation portion. The operation button is utilized for controlling the micro processor.

The micro processor receives a sequence of the distance signals and the angle signals, and renovates the horizontal distance label displayed on the screen continuously, so that the horizontal distance between the range detector and the object is shown by the horizontal distance label instantaneously.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is another stereogram showing a first embodiment of the present invention;

FIG. 3 is a front view showing a first embodiment of the present invention;

FIG. 4 is a schematic drawing showing an operation condition of a first embodiment of the present invention;

FIG. 4A is a front view showing a screen in an operation condition of a first embodiment of the present invention;

FIG. 5 is a schematic drawing showing another operation condition of a first embodiment of the present invention;

FIG. 5A is a front view showing a screen in another operation condition of a first embodiment of the present invention.

### DETAILED DESCRIPTION OF THE PREFERRED EMBODIMENTS

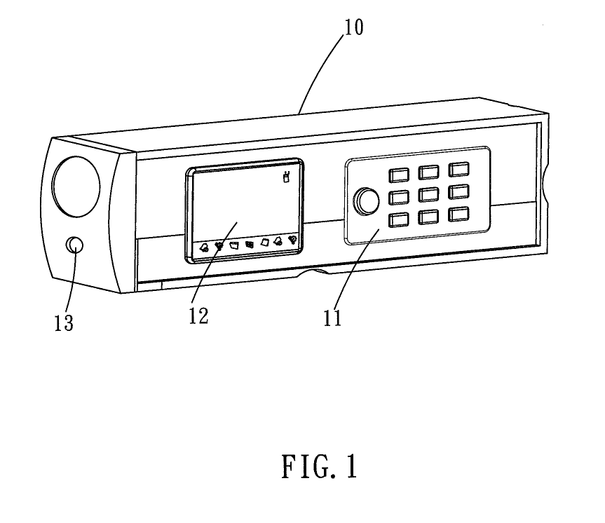

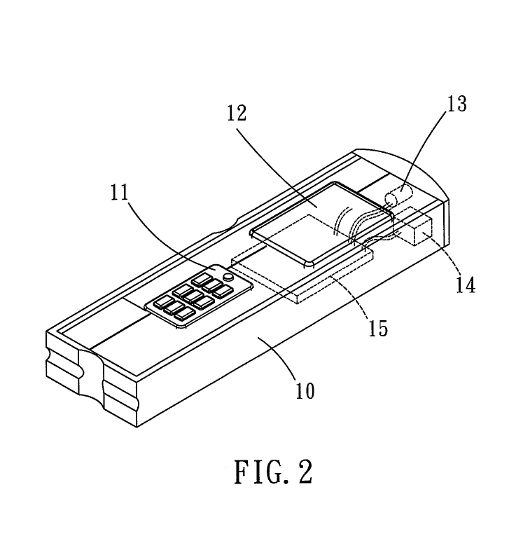

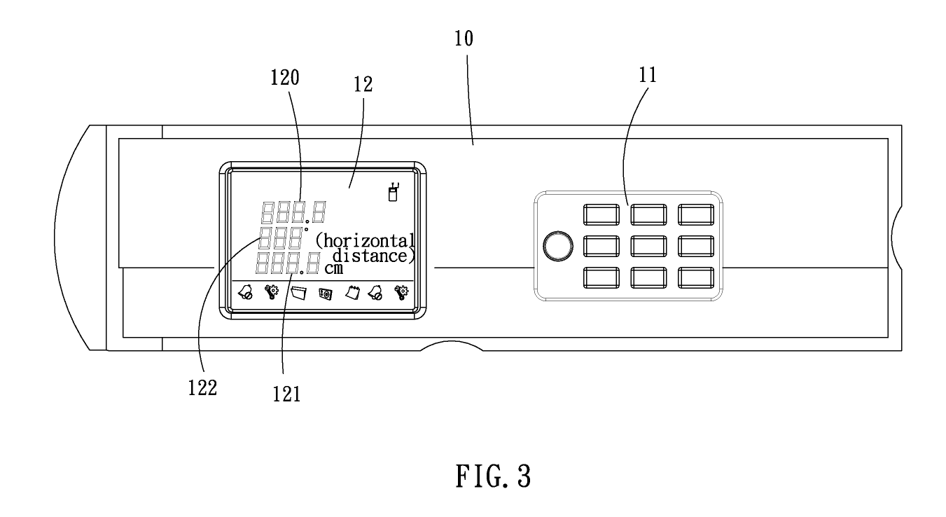

Please refer to FIG. 1 to FIG. 5 for a first embodiment of the present invention. The laser rangefinder of the present embodiment includes a main body 10 and a power supplier. One surface of the main body 10 is disposed with an operation portion 11 and a screen 12. The operation portion includes one or plural operation buttons. The operation buttons are utilized for being pressed to control the laser rangefinder. The screen 12 is firmly disposed on the main body 10, being controlled to displaying image provided for user to observe. Preferably, the screen 12 may be disposed as a touch screen, so that the screen 12 is also utilized for controlling the laser rangefinder. User can control the laser rangefinder with the screen 12 directly. Another surface of the main body 10 is disposed with a range detector 13. The range detector 13 is firmly disposed on the main body 10 and is connected to the power supply. The range detector 13 is able to emit a pulse signal along a detection direction. Typically, the pulse signal may be carried on infrared rays, laser, visible light, or similar radiation. The pulse signal would be reflected by an object after it is emitted. The range detector 13 receives the pulse signal which is reflected by the object, and generates a distance signal. The distance signal corresponds to a value of a distance between the range detector 13 and the object. Further, the distance between the range detector 13 and the object is substantially equal to a distance between the main body and the object since the range detector 13 is located on the main body. In practical, the range detector 13 may include a radiation projector and a radiation receiver. Preferably, the receiver has high sensitive and low noise function.

An angle detector 14 and a micro processor 15 are firmly disposed in the main body 10. The angle detector 14 generates an angle signal corresponding to a value of an oblique angle θ defined between the detection direction of the range detector 13 and a horizontal direction. The micro processor 15 is connected to the operation portion 11, the screen 13, the range detector 13, and the angle detector 14. The micro processor 15 would be controlled and operated according to operation of the operation button of the operation portion 11 so as to be turned on, turned off, or switched the working status of the micro processor 15. The micro processor 15 can receives the distance signal from the range detector 13 and the angle signal from the angle detector 14. Thus, the micro processor 15 can obtain the value of actual distance z and oblique angle θ. Furthermore, the micro processor 15 can obtain value of horizontal distance x or vertical distance y according to the distance signal, the angle signal, and trigonometric functions. In practical design of the laser rangefinder, length of the main body may be added in the actual distance for calculation.

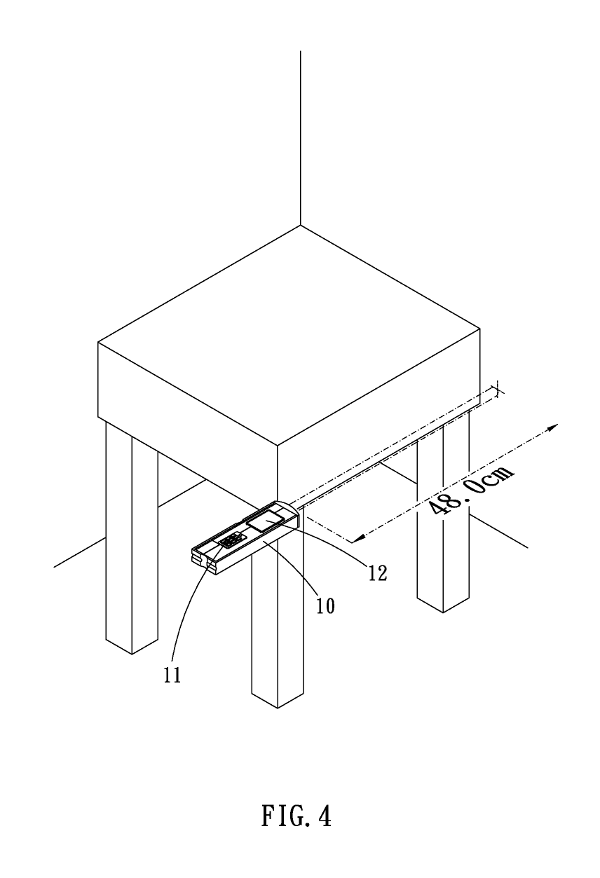

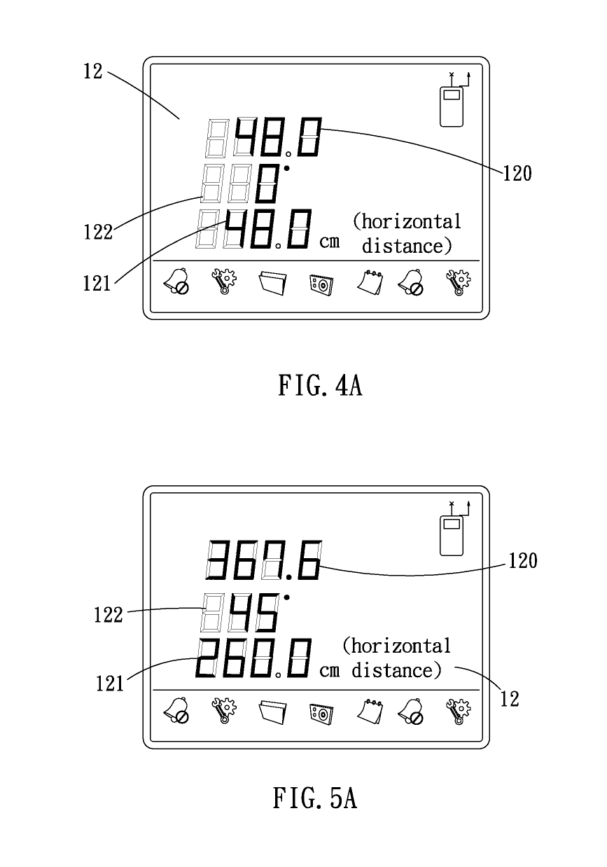

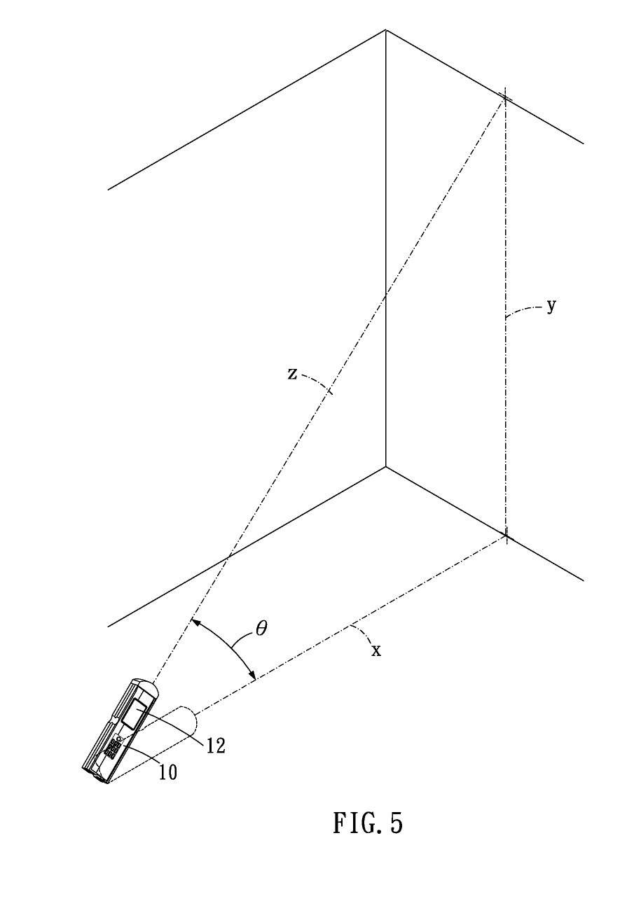

The micro processor 15 is also connected to the screen 12, so that the micro processor 15 is able to control the screen 12 to display image. Thus, the micro processor 15 can control the screen 12 to display a horizontal distance label 121 according to the horizontal distance x. Further, angle label 122 corresponding to the oblique angle θ, actual distance label 120 corresponding to the actual distance z, and vertical distance label corresponding to the vertical distance y may be displayed on the screen 12, as shown in FIG. 4, FIG. 4A, FIG. 5, and FIG. 5A. In addition, the labels 120, 121 may be displayed as one or more of metric system, imperial system, and other systems.

It is noted that in the present embodiment, the power supplier is disposed in a board of the micro processor 15. The power supplier may take the form of a battery. In other embodiments of the present invention, the battery of the power supplier may be individual from the micro processor 15, or the power supplier may be a plug which is able to be connected to other power supplier.

Accordingly, in practical operation, user can press the operation button of the operation portion 11 firstly. The range detector 13 would project a pulse signal forward along a detection direction. The pulse signal would be reflected by an object, such as a wall, so that the range detector 13 can receive the pulse signal after it is reflected. Thus, the range detector or the laser rangefinder can obtain the data of distance of the object from the laser rangefinder. Further, calculation or transmission is then down as mentioned above so as to display the labels on the screen 12. User can read the horizontal distance, the actual distance, and the oblique angle from the screen directly.

By the operation above, user can obtain horizontal distance of an object from the laser rangefinder or the user directly. Inaccuracy caused by inclined of manual operation is staked out. Thus, convenience and accuracy of measurement are improved. Quality, accuracy, and efficiency of building construction can be maintained well. In addition, additional data such as oblique angle can also be read on the screen so as to be provided for user as a reference material.

Furthermore, the range detector 13 and the angle detector 14 would execute the detection continuously or intermittently when the micro processor 15 is turned on. For instance, the range detector 13 and the angle detector 14 may generate a set of distance signal and angle signal in every 0.2 second. The micro processor 15 would receive a sequence of distance signals and angle signals, and the micro processor 15 would renovate the horizontal distance label and other labels displayed in the screen 12 continuously. Thus, the horizontal distance between the range detector and the object is shown by the horizontal distance label instantaneously. User can read the data from the screen immediately after the laser rangefinder is moved.

What is claimed is:

1. A laser rangefinder, comprising:
a main body;
a power supplier;
a range detector, firmly disposed on a surface of the main body, the range detector being connected to the power supplier, the range detector emitting a pulse signal toward an object along a detection direction, the range detector receiving the pulse signal after the pulse signal is reflected by the object, the range detector generating a distance signal corresponding to a value of a distance between the range detector and the object which is substantially equal to a value of a distance between the main body and the object;
an angle detector, firmly disposed in the main body, the angle detector generating an angle signal corresponding to a value of an oblique angle defined between the detection direction and a horizontal direction;
a micro processor, connected to the range detector and the angle detector, the micro processor receiving the distance signal and the angle signal so as to provide a horizontal distance according to the distance signal and the angle signal;
a screen, firmly disposed on the main body, the screen being connected to the micro processor, the micro processor controlling the screen to display image, the micro processor controlling the screen to display a horizontal distance label according to the horizontal distance;
an operation portion, firmly disposed on the main body, the operation portion comprising at least one operation button, the micro processor connecting to the operation portion, the operation button being utilized for controlling the micro processor;
wherein the micro processor receives a sequence of the distance signals and the angle signals, and renovates the horizontal distance label displayed on the screen continuously, so that the horizontal distance between the range detector and the object is shown by the horizontal distance label instantaneously.

2. The laser rangefinder of claim 1, wherein the micro processor controls the screen to display an actual distance label according to the distance signal, and the micro processor controls the screen to display an oblique angle label according to the angle signal.

3. The laser rangefinder of claim 1, wherein the screen is a touch screen, so that the screen is also utilized for controlling the micro processor.
